(19) United States
(12) Patent Application Publication
(10) Pub. No.: US 2025/0037162 A1
(43) Pub. Date: Jan. 30, 2025

(54) SALES PROMOTION PROPOSAL DEVICE, SALES PROMOTION PROPOSAL METHOD, AND RECORDING MEDIUM

(71) Applicant: NEC Corporation, Tokyo (JP)

(72) Inventors: Kei SHIBUKAWA, Tokyo (JP); Yuto Nakaya, Tokyo (JP); Naru Otsuka, Tokyo (JP)

(73) Assignee: NEC Corporation, Tokyo (JP)

(21) Appl. No.: 18/770,513

(22) Filed: Jul. 11, 2024

(30) Foreign Application Priority Data
Jul. 26, 2023 (JP) 2023-121369

(51) Int. Cl. G06Q 30/0251; G06Q 30/0241

(52) U.S. Cl. CPC G06Q 30/0255; G06Q 30/0276

(57) ABSTRACT

A sales promotion proposal device of the present disclosure includes: an acquisition means for acquiring posted information on a media of a product sold in a store and reaction information on an Internet to the posted information; a proposal means for suggesting a sales promotion method in a store of a posted product posted on the media based on the posted information and the reaction information; and an output means for outputting the suggested sales promotion method.

This application is based upon and claims the benefit of priority from Japanese Patent Application No. 2023-121369, filed on Jul. 26, 2023, the disclosure of which is incorporated herein in its entirety by reference.

### TECHNICAL FIELD

The present disclosure relates to a sales promotion proposal device, a sales promotion proposal method, and a recording medium.

### BACKGROUND ART

Information posted on a media or a social networking service (SNS) may be used to promote products sold at a store.

For example, JP 2014-238734 A discloses that sales promotion information is generated by using content of a television program whose viewing history information satisfies a setting condition among content of the television program including content related to a product.

An object of the present disclosure is to provide a sales promotion proposal device capable of proposing a more effective sales promotion method.

### SUMMARY

A sales promotion proposal device according to an aspect of the present disclosure includes: an acquisition means for acquiring posted information on a media of a product sold in a store and reaction information on an Internet to the posted information; a proposal means for suggesting a sales promotion method in a store of a posted product posted on the media based on the posted information and the reaction information; and an output means for outputting the suggested sales promotion method.

A sales promotion proposal method according to an aspect of the present disclosure causes a computer to execute: acquiring posted information on a media of a product sold in a store and reaction information on an Internet to the posted information; suggesting a sales promotion method in a store of a posted product posted on the media based on the posted information and the reaction information; and outputting the suggested sales promotion method.

A non-transitory recording medium according to an aspect of the present disclosure has stored therein a program for causing a computer to execute: acquiring posted information on a media of a product sold in a store and reaction information on an Internet to the posted information; suggesting a sales promotion method in a store of a posted product posted on the media based on the posted information and the reaction information; and outputting the suggested sales promotion method.

### BRIEF DESCRIPTION OF THE DRAWINGS

Exemplary features and advantages of the present invention will become apparent from the following detailed description when taken with the accompanying drawings in which:

FIG. 1 is a functional block diagram illustrating an example of a sales promotion proposal device in the present disclosure;

FIG. 2 is a diagram illustrating a hardware configuration in which the sales promotion proposal device according to the present disclosure is implemented by a computer device and its peripheral devices;

FIG. 3 is an example of an output screen of the sales promotion method in the present disclosure;

FIG. 4 is an example of an output screen of the sales promotion method in the present disclosure;

FIG. 5 is an example of an output screen of the sales promotion method in the present disclosure;

FIG. 6 is a flowchart illustrating an operation of sales promotion proposal in the present disclosure;

FIG. 7 is a functional block diagram illustrating an example of the sales promotion proposal device in the present disclosure; and

FIG. 8 is a flowchart illustrating an operation of sales promotion proposal in the present disclosure.

### EXAMPLE EMBODIMENT

Hereinafter, example embodiments of a sales promotion proposal device, a sales promotion proposal method, a program, and a non-transitory recording medium recording the program according to the present disclosure will be described in detail with reference to the drawings. The present example embodiments do not limit the present disclosure.

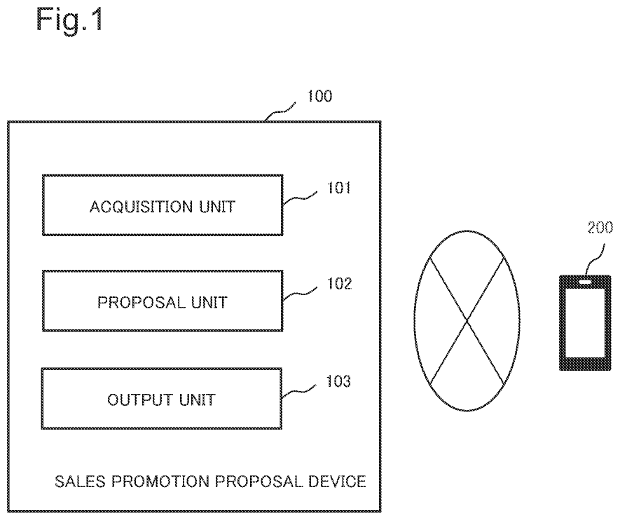

FIG. 1 is a functional block diagram illustrating an example of a configuration of a sales promotion proposal device 100 in the present disclosure. As illustrated in FIG. 1, the sales promotion proposal device 100 includes an acquisition unit 101, a proposal unit 102, and an output unit 103.

For example, the sales promotion proposal device 100 in the present disclosure is a device for proposing effective sales promotion information on a product sold in a store based on posted information posted on a media and a reaction of the posted information. A store is a store where a customer purchases a product displayed on a shelf, and includes a retail business or a wholesale business. Examples of the retail business include a bookstore, a department store/supermarket, a convenience store, a home appliance, a home appliance store, and a specialty retail store such as a drug store, and the business form is not limited.

The sales promotion proposal device 100 displays a sales promotion method of the posted product on a store terminal 200 or the like through the network. The store terminal 200 is, for example, a display device provided in a backyard of a store or a terminal device carried by a store clerk. The store terminal 200 may be a display device installed on a shelf.

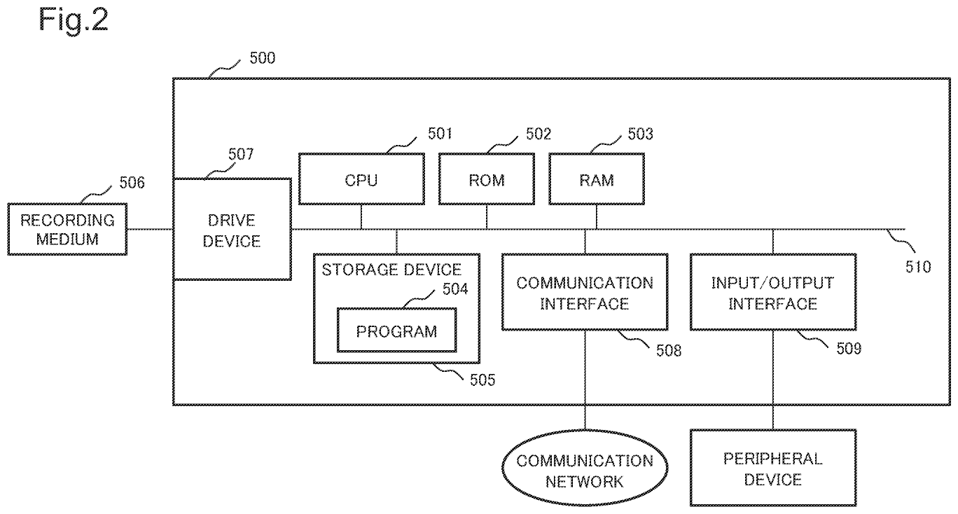

FIG. 2 is a diagram illustrating an example of a hardware configuration in which the sales promotion proposal device 100 is implemented by a computer device 500 including a processor. As illustrated in FIG. 2, the sales promotion proposal device 100 includes a memory such as a central processing unit (CPU) 501, a read only memory (ROM) 502, and a random access memory (RAM) 503, a storage device 505 such as a hard disk that stores a program 504, a communication interface 508 for network connection, and an input/output interface 509 that inputs and outputs data.

In the present disclosure, the constituent units in the sales promotion proposal device 100 are connected to each other via, for example, a bus 510. The sales promotion proposal device 100 illustrated in FIG. 1 can also be configured by cloud computing or the like.

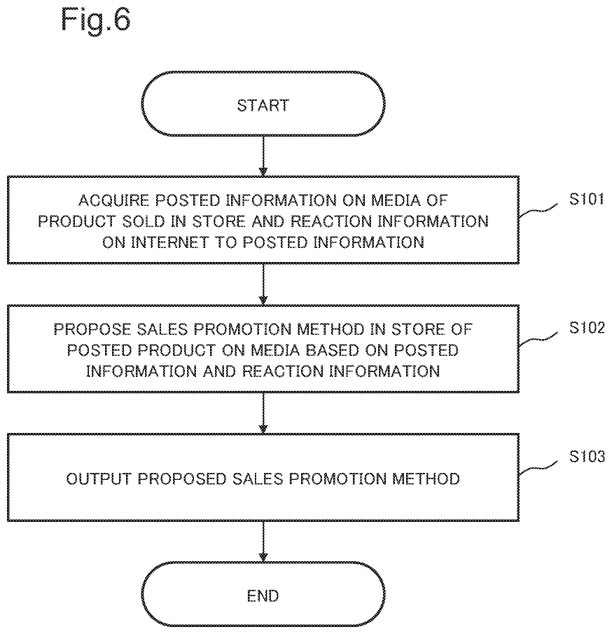

The CPU 501 operates the operating system to control the entire sales promotion proposal device 100 according to the present disclosure. The CPU 501 reads a program and data from a recording medium 506 mounted on, for example, a drive device 507 to a memory. The CPU 501 functions as the acquisition unit 101, the proposal unit 102, the output unit 103, and a part thereof, and executes processing or commands in the flowchart illustrated in FIG. 6 to be described later based on the program.

The recording medium 506 is, for example, an optical disk, a flexible disk, a magnetic optical disk, an external hard disk, a semiconductor memory, or the like. A semiconductor memory or the like which is a part of the recording medium is a non-volatile storage device, and records a program therein. The program may be downloaded from an external computer (not illustrated) connected to a communication network.

As described above, the sales promotion proposal device 100 illustrated in FIG. 1 is implemented by the computer hardware illustrated in FIG. 2. However, the means for implementing each unit included in the sales promotion proposal device 100 of FIG. 1 is not limited to the configuration described above. The sales promotion proposal device 100 may be implemented by one physically coupled device, or may be implemented by a plurality of devices by connecting two or more physically separated devices in a wired or wireless manner. The sales promotion proposal device 100 may further include a display device such as a display, or may be configured as a system implemented by a device separate from the display device.

The acquisition unit 101 is a means for acquiring posted information on a media of a product sold in a store and reaction information on the Internet to the posted information. For example, the acquisition unit 101 acquires, as the posted information in the media, information of a product posted in a television program, the Internet including an SNS or the like, a newspaper, a magazine, a radio program, a transportation advertisement posted on a public transportation vehicle or a station yard, or the like within a predetermined period from the present time. In the present disclosure, posting is not limited to displaying a specific product name on a media, but also includes introducing information that identifies a product name or a product verbally.

Specific examples of the posted information include information that can identify a media on which a product is posted, such as a media name and a posted date. For a television program or a radio program, the posted information includes a program name and a broadcast date. For the Internet, the posted information includes a site name and a posted date. For a newspaper, the posted information includes the newspaper name and the issued date. For a magazine, the posted information includes the magazine name and the issued date. The posted information of the traffic advertisement is, for example, a posted place and a posted date.

The acquisition unit 101 acquires the posted information in each media by a known method. For example, in the case of a television program, the acquisition unit 101 acquires the posted information posted on a program site of each broadcasting station. For example, the acquisition unit 101 may acquire the posted information from an external database that summarizes information on products posted on each media.

For example, the acquisition unit 101 acquires, as the reaction information, a content of posting and the number of times of posting to the posted information posted on the Internet. The reaction information in the present disclosure is not limited to information posted on a generally widely known SNS as long as it can be detected that some information regarding the posted information has been posted and that some operation has been performed on the posted information.

The acquisition unit 101 may acquire some kind of reaction left by the viewer who has browsed the post to the posted information. Examples of the reaction include the number of engagements with respect to posts, the number of comments with respect to posts, the number of replies with respect to comments, and a reply rate with respect to comments, but the reaction is not limited thereto as long as it is an index indicating the reaction. The acquisition unit 101 acquires the reaction information on the post to the posted information using an access analysis tool or the like. When acquiring the posted information and the reaction information thereof by the above-described method, the acquisition unit 101 stores the posted information and the reaction information in the storage device 505 in association with each other.

The proposal unit 102 proposes a sales promotion method in the store of the posted product based on the posted information and the reaction information. For example, the proposal unit 102 proposes a sales promotion method according to the degree of attention to the posted product. The degree of attention is, for example, a value indicating a degree of attention to the posted product calculated based on the posted information and the reaction information.

For example, the proposal unit 102 may calculate the degree of attention of the posted product by assigning a score to the posted information and the reaction information on the Internet to the posted information. In this case, for example, the proposal unit 102 gives a score to the posted information based on at least one of items of name value, performer, average viewing rate, and average number of browses of a media on which the posted product is posted. The proposal unit 102 may give a high score to an item that leads to an improvement in the degree of attention of the posted product. For example, in a case where an item is posted on a media in which a famous person appears or a medium in which an average viewing rate or an average number of browses is equal to or larger than a reference value of a predetermined value, the score may be added as compared with a case where the famous person appears in another media. For example, the proposal unit 102 may change the score to be given to the reaction information according to the number of times of posting to the posted information, the number of engagements to the posting, and the like.

For example, the proposal unit 102 may propose a sales promotion method in the store of the posted product based on the past posted information and reaction information of the similar product similar to the posted product and the sales situation of the similar product due to being posted. The similar product of the posted product is, for example, another product belonging to the same product category, and if the product is food, the classification may be a large category such as a sales shop including vegetables, meat, confectionery, frozen food, fresh food, seasoning, and the like. The product may be classified into small categories such as potato chips and curry roux. When the product is a book, the similar product is, for example, a book written by the same author or an author whose style is similar. However, the similar product is not limited to the example described above.

For example, the proposal unit 102 predicts the sales of the posted product based on the relationship between the reaction information to the posted information and the sales record indicating the sales situation of the similar product in the past in a case where the similar product has been posted on the similar medium in the past. More specifically, the proposal unit 102 may take in, as teacher data, reaction information to the posted information and the like, and daily or weekly sales record, and make a prediction using a model subjected to machine learning. This model is generated in advance by a generation means (not illustrated) and stored in the storage device 505, for example.

The proposal unit 102 proposes a position where a posted product is displayed as a sales promotion method. The proposal unit 102 proposes to display the posted product at a position that is more noticeable to the customer as the degree of attention or the predicted value of sales is higher. For example, in a case where the product is a book, if the degree of attention or the predicted value of sales of the posted product is equal to or greater than a predetermined reference value, the proposal unit 102 may propose to stack the products flat on the end shelves at both ends of the shelf on which the product is displayed, and if the degree of attention or the predicted value of sales of the posted product is less than the predetermined reference value, the proposal unit 102 may propose to arrange the products such that only the spine is visible, similarly to other products. In this case, the sales promotion method can be decided to display the product in an appropriate display position in accordance with sales of the target product. The proposal unit 102 may propose the number of posted products to be displayed based on the degree of attention of the posted products or the predicted value of sales.

The proposal unit 102 may propose the content of a point of purchase (POP) used for sales promotion of the posted product as a sales promotion method. The POP is an advertisement media installed mainly for product promotion at retail stores. For example, if there is a comment by a famous celebrity or influencer in posting media or posted information, the proposal unit 102 may propose the content of the POP using the comment. In this case, the posted product is likely to be noticed by customers who know the media on which the posted product is posted and the posted content for the media.

The output unit 103 is a means for outputting the proposed sales promotion method. The output unit 103 outputs the sales promotion method to the store terminal 200, for example. The output unit 103 may print the sales promotion method using a printing device. The output unit 103 may output the degree of attention or the predicted value of sales used to propose the sales promotion method together with the sales promotion method.

In a case where the timing to determine the sales promotion method is determined, the output unit 103 may output the sales promotion method of the target product to the store terminal 200 as an e-mail or a message at that timing. Examples of the timing include a timing before the start of business or a scheduled time for product release. The output unit 103 may output the sales promotion method with an operation of a store clerk for browsing the sales promotion method of the target product on the dedicated site or the application as a trigger.

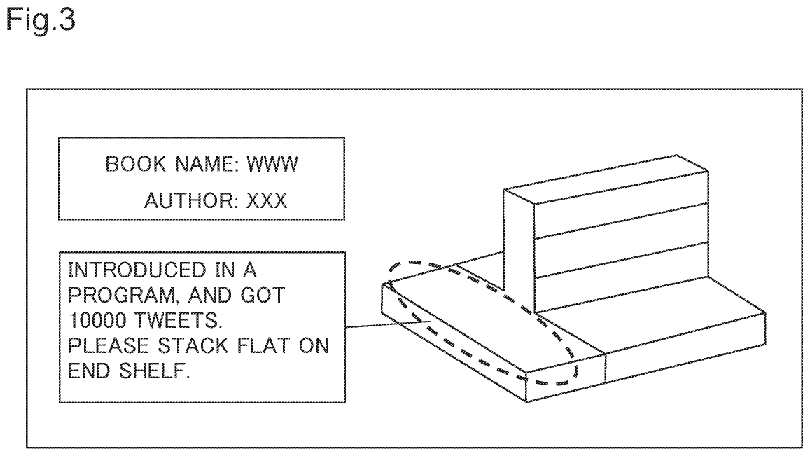

Here, an example of an output screen of the sales promotion method will be described with reference to FIGS. 3 to 5. In the examples of FIGS. 3 to 5, in a case where the target product is a book name “XXX” and the degree of attention is a predetermined reference value, the proposal unit 102 proposes to display the target product on an end shelf that is easily noticed. In the example of FIGS. 3 to 5, it is assumed that the predetermined reference value of the degree of attention is 5000 tweets with respect to the posted information. FIG. 3 is an example of an output screen of a position where a posted product is displayed. In the example of FIG. 3, a product is introduced by the program A having a high audience rating, the number of tweets for the posted information is 10,000, and the degree of attention is higher than the predetermined reference value. Therefore, it is assumed that the number of customers who purchase this book is expected to increase. In this case, as illustrated in FIG. 3, the output unit 103 outputs displaying in a flat stack on an end shelf that is easily noticeable.

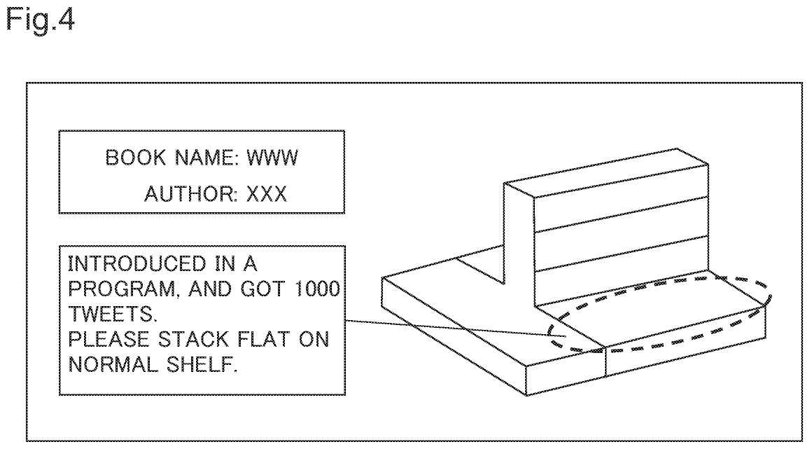

FIG. 4 is an example of an output screen of a position where a posted product is displayed. In the example of FIG. 4, although the product is introduced in the program A having a high audience rating, the number of tweets for the posted information is 1000, and the degree of attention is lower than the predetermined reference value. In this case, as illustrated in FIG. 4, the output unit 103 outputs displaying in a flat stack on a normal shelf, not on an end shelf.

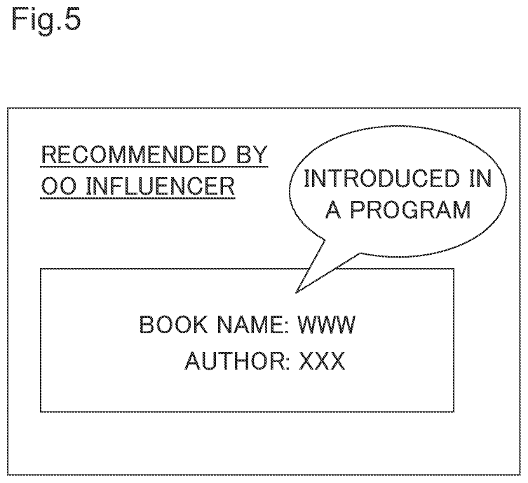

FIG. 5 is an example of an output screen in a case where the content of the POP used for sales promotion of a posted product is proposed. In the example of FIG. 5, it is assumed that the product is introduced in the program A having a high audience rating, and a well-known influencer tweets the posted information. In this case, as illustrated in FIG. 5, the output unit 103 outputs the content of the POP in which it is described that the book name “XXX” has been introduced in the program A and that it has been recommended by a famous influencer. The output unit 103 may directly output the content of the POP illustrated in FIG. 5 to a display device installed on a shelf.

The operation of the sales promotion proposal device 100 configured as described above will be described with reference to the flowchart of FIG. 6.

FIG. 6 is a flowchart illustrating an outline of an operation of the sales promotion proposal device 100 in the present disclosure. The processing according to this flowchart may be executed based on program control by the processor described above. The processing according to this flowchart is started, for example, when an operation of a store clerk for browsing the sales promotion method of the target product is detected as a trigger.

As illustrated in FIG. 6, first, the acquisition unit 101 acquires posted information on a media of a product sold in a store and reaction information on the Internet to the posted information (step S101). Next, the proposal unit 102 proposes a sales promotion method in the store of the posted product posted on the media based on the posted information and the reaction information (step S102). The output unit 103 outputs the proposed sales promotion method (step S103). Thus, the sales promotion proposal device 100 terminates the operation.

In the sales promotion proposal device 100, the proposal unit 102 proposes a sales promotion method in a shop for a posted product based on posted information and reaction information on the Internet. Then, the output unit 103 outputs the proposed sales promotion method. As a result, it is possible to propose the target product method by using not only the content of the television program having a high audience rating but also various information related to the target product. Therefore, the sales promotion proposal device 100 can propose a more effective sales promotion method.

In the sales promotion proposal device 100, the proposal unit 102 may predict the sales of the posted product based on the relationship between the reaction information to the posted information and the sales record value indicating the past sales situation of the similar product when the similar product has been previously posted on the similar media. In this case, for example, when similar products have been posted on a specific media in the past and the response on the Internet has been great, it can be predicted that sales of products posted under similar conditions will increase.

### SECOND EXAMPLE EMBODIMENT

Next, a second example embodiment of the present disclosure will be described in detail with reference to the drawings. Hereinafter, description of contents overlapping with the above description will be omitted to the extent that the description of the present example embodiment is not unclear. Similarly to the computer device illustrated in FIG. 2, each component in each example embodiment of the present disclosure can be achieved not only by hardware but also by a computer device or software based on program control.

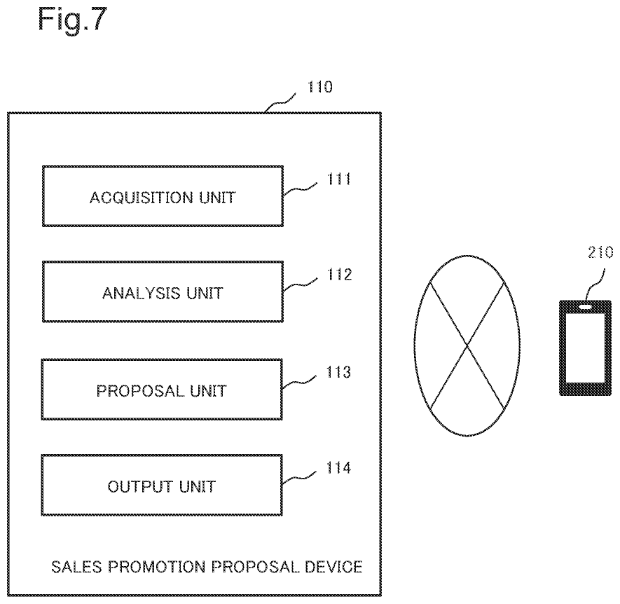

FIG. 7 is a functional block diagram illustrating an example of a sales promotion proposal device 110 of the present disclosure. With reference to FIG. 7, the sales promotion proposal device 110 will be described focusing on a part different from the sales promotion proposal device 100.

The sales promotion proposal device 110 includes an acquisition unit 111, an analysis unit 112, a proposal unit 113, and an output unit 114. The acquisition unit 111, the proposal unit 113, and the output unit 114 have the same configuration and function as the corresponding components in the first example embodiment.

The analysis unit 112 is a means for analyzing the reaction of the posted product based on the reaction information. For example, the analysis unit 112 analyzes an attribute of a posted product based on a post to the posted information. The attribute is information indicating a feature of the posted product included in the posted information or an impression or an opinion on the posted product by a customer who has purchased the posted product.

The analysis unit 112 analyzes the attribute of the posted product by, for example, the following procedure. That is, the analysis unit 112 extracts a portion related to the attribute of the posted product from among the keywords in the document included in the posted information, the image, or the hash tag attached to the post. Next, the analysis unit 112 analyzes the extracted portion by performing natural language processing, image processing (a known method may be used), or other mechanical processing, and imparts an attribute. of the posted product to each post. The analysis unit 112 counts the attribute given to each post. Then, the proposal unit 113 proposes to use the POP using the imparted attribute a predetermined number of times or more.

For example, in a case where the target product is a book, the proposal unit 113 gives an attribute related to an impression or content of the book. Examples of the attribute given to the book include “impressed”, “sad”, “happy end”, and “reversal”. For example, the proposal unit 113 proposes to use the POP including a catch copy such as “shocking ending” when there are many tweets like “shocking ending” for a suddenly developing story. However, the method of adding the attribute by the proposal unit 113 is not limited thereto.

Then, the proposal unit 113 may propose the shelf allocation of the products sold in the store based on the imparted attribute. For example, the proposal unit 113 may propose shelf allocation in which products having the same or similar attributes are arranged within a predetermined distance.

In the above-described example, the analysis unit 112 analyzes the attribute of the posted product, but the analysis unit 112 may analyze the attribute of the customer who pays attention to the posted product based on the reaction information. The analysis unit 112 estimates an attribute such as age or gender of the contributor from the posted information or the profile information of the contributor. Then, the analysis unit 112 specifies the gender or the age at which many posts to the posted information are made.

Then, the proposal unit 113 proposes the content of the POP targeting the specified gender or age. Specifically, the proposal unit 113 changes the use of colors, the font size, the number of characters, or the presence or absence of illustrations of the POP based on at least one of the gender or the age of the main target of the target product. For example, when the main target is young women, the proposal unit 113 proposes to create a POP of a bright color. When the main target is elderly persons, the proposal unit proposes to create a POP of large characters. When the main target is male persons, the proposal unit proposes to create a simple POP. However, this POP proposal example is merely an example, and the proposal unit 113 may propose to create another POP.

A sales promotion proposal output method by the output unit 114 in the sales promotion proposal device 110 is similar to that of the output unit 103 of the first example embodiment.

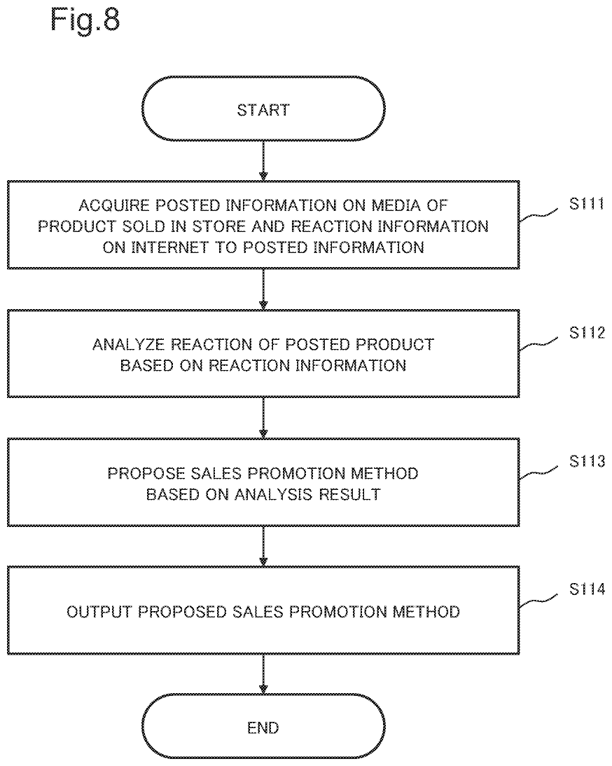

FIG. 8 is a flowchart illustrating an outline of an operation of the sales promotion proposal device 110. The processing according to this flowchart may be executed based on program control by the processor described above.

As illustrated in FIG. 8, first, the acquisition unit 111 acquires posted information on a media of a product sold in a store and reaction information on the Internet to the posted information (step S111). Next, the analysis unit 112 analyzes the reaction of the posted product based on the reaction information (step S112). Next, the proposal unit 113 proposes a sales promotion method for the posted product based on the analysis result (step S113). The output unit 114 outputs the proposed sales promotion method (step S114). Thus, the sales promotion proposal device 110 terminates the operation.

In the sales promotion proposal device 110, the analysis unit 112 analyzes the reaction of the posted product based on the reaction information, and the proposal unit 113 proposes a sales promotion method for the posted product based on the analysis result. Then, the output unit 114 outputs the proposed sales promotion method. As a result, it is possible to calculate a sales promotion method matching the public reputation of the posted product.

In the sales promotion proposal device 110, the analysis unit 112 may analyze the attribute of the posted product based on the reaction information, and the proposal unit 113 may propose the shelf allocation of the product based on the attribute. In this case, for example, by displaying a product similar to the posted product nearby, it is possible to increase the possibility that the customer purchases a product similar to the posted product at the same time.

In the sales promotion proposal device 110, the analysis unit 112 may analyze the attribute of the customer who pays attention to the product based on the reaction information, and the proposal unit 113 may propose the content of the POP targeting the attribute. In this case, for example, it is possible to propose an effective content of the POP to a customer who is interested in the posted product.

Although the present disclosure has been particularly shown and described with reference to the present example embodiment, the present disclosure is not limited to the above example embodiment. It will be understood by those of ordinary skill in the art that various changes in form and details may be made therein without departing from the spirit and scope of the present disclosure as defined by the claims.

For example, although the plurality of operations are described in order in the form of a flowchart, the order of description does not limit the order of executing the plurality of operations. Therefore, when each example embodiment is implemented, the order of the plurality of operations can be changed within a range that does not interfere with the content.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

In recent years, consumers can freely give opinions on the Internet, and sales of products introduced in TV programs cannot be measured only by a viewing history of viewing the programs. Therefore, it is required to effectively promote products by using various information of the products introduced in the media.

An example of an effect of the present disclosure is to provide a sales promotion proposal device capable of proposing a more effective sales promotion method.

Some or all of the above example embodiments may be described as the following Supplementary Notes, but are not limited to the following.

### (Supplementary Note 1)

A sales promotion proposal device including:
an acquisition means for acquiring posted information on a media of a product sold in a store and reaction information on an Internet to the posted information;
a proposal means for suggesting a sales promotion method in a store of a posted product posted on the media based on the posted information and the reaction information; and
an output means for outputting the suggested sales promotion method.

### (Supplementary Note 2)

The sales promotion proposal device according to Supplementary Note 1, in which the proposal means proposes a position where the posted product is displayed.

### (Supplementary Note 3)

The sales promotion proposal device according to Supplementary Note 1, in which the proposal means proposes a content of a POP used for sales promotion of the posted product.

### (Supplementary Note 4)

The sales promotion proposal device according to Supplementary Note 1, in which the proposal means proposes a sales promotion method in a store of the posted product based on past posted information and reaction information of a similar product similar to the posted product and a sales situation of the similar product.

### (Supplementary Note 5)

The sales promotion proposal device according to any one of Supplementary Notes 1 to 4, further including:
an analysis means for analyzing reaction of a posted product based on the reaction information, in which
the proposal means proposes a sales promotion method for the posted product based on an analysis result.

### (Supplementary Note 6)

The sales promotion proposal device according to Supplementary Note 5, in which
the analysis means analyzes an attribute of the posted product based on the reaction information, and
the proposal means proposes a shelf allocation of a product in the store based on an attribute of the posted product.

### (Supplementary Note 7)

The sales promotion proposal device according to Supplementary Note 5, in which
the analysis means analyzes an attribute of a customer who pays attention to the posted product based on the reaction information, and
the proposal means proposes a content of a POP targeting an attribute of the customer.

### (Supplementary Note 8)

A sales promotion proposal method causing a computer to execute:
acquiring posted information on a media of a product sold in a store and reaction information on an Internet to the posted information;
suggesting a sales promotion method in a store of a posted product posted on the media based on the posted information and the reaction information; and
outputting the suggested sales promotion method.

### (Supplementary Note 9)

The sales promotion proposal method according to Supplementary Note 8, in which a position where the posted product is displayed is proposed in the proposing.

### (Supplementary Note 10)

The sales promotion proposal method according to Supplementary Note 8, in which a content of a POP used for sales promotion of the posted product is proposed in the proposing.

### (Supplementary Note 11)

The sales promotion proposal method according to Supplementary Note 8, in which a sales promotion method in a store of the posted product is proposed in the proposing based on past posted information and reaction information of a similar product similar to the posted product and a sales situation of the similar product.

### (Supplementary Note 12)

The sales promotion proposal method according to any one of Supplementary Notes 8 to 11, further including:
analyzing reaction of a posted product based on the reaction information, in which
a sales promotion method for the posted product is proposed in the proposing based on an analysis result.

### (Supplementary Note 13)

The sales promotion proposal method according to Supplementary Note 12, in which
an attribute of the posted product is analyzed in the analyzing based on the reaction information, and
a shelf allocation of a product in the store is proposed in the proposing based on an attribute of the posted product.

### (Supplementary Note 14)

The sales promotion proposal method according to Supplementary Note 12, in which
an attribute of a customer who pays attention to the posted product is analyzed in the analyzing based on the reaction information, and
a content of a POP targeting an attribute of the customer is proposed in the proposing.

### (Supplementary Note 15)

A non-transitory recording medium having stored therein a program for causing a computer to execute:
acquiring posted information on a media of a product sold in a store and reaction information on an Internet to the posted information;
suggesting a sales promotion method in a store of a posted product posted on the media based on the posted information and the reaction information; and
outputting the suggested sales promotion method.

### (Supplementary Note 16)

The non-transitory recording medium according to Supplementary Note 15, in which a position where the posted product is displayed is proposed in the proposing.

### (Supplementary Note 17)

The non-transitory recording medium according to Supplementary Note 15, in which a content of a POP used for sales promotion of the posted product is proposed in the proposing.

### (Supplementary Note 18)

The non-transitory recording medium according to Supplementary Note 15, in which a sales promotion method in a store of the posted product is proposed in the proposing based on past posted information and reaction information of a similar product similar to the posted product and a sales situation of the similar product.

### (Supplementary Note 19)

The non-transitory recording medium according to any one of Supplementary Notes 15 to 18, further including:
analyzing reaction of a posted product based on the reaction information, in which
a sales promotion method for the posted product is proposed in the proposing based on an analysis result.

### (Supplementary Note 20)

The non-transitory recording medium according to Supplementary Note 19, in which
an attribute of the posted product is analyzed in the analyzing based on the reaction information, and
a shelf allocation of a product in the store is proposed in the proposing based on an attribute of the posted product.

### (Supplementary Note 21)

The non-transitory recording medium according to Supplementary Note 19, in which
an attribute of a customer who pays attention to the posted product is analyzed in the analyzing based on the reaction information, and
a content of a POP targeting an attribute of the customer is proposed in the proposing.

1. A sales promotion proposal device comprising:
a memory storing instructions; and
at least one processor configured to execute the instructions to:
acquire posted information on a media of a product sold in a store and reaction information on an Internet to the posted information;
suggest a sales promotion method in a store of a posted product posted on the media based on the posted information and the reaction information; and
output the suggested sales promotion method.

2. The sales promotion proposal device according to claim 1, wherein the at least one processor is further configured to execute the instructions to:
propose a position where the posted product is displayed.

3. The sales promotion proposal device according to claim 1, wherein the at least one processor is further configured to execute the instructions to:
propose a content of a point of purchase (POP) used for sales promotion of the posted product.

4. The sales promotion proposal device according to claim 1, wherein the at least one processor is further configured to execute the instructions to:
propose a sales promotion method in a store of the posted product based on past posted information and reaction information of a similar product similar to the posted product and a sales situation of the similar product.

5. The sales promotion proposal device according to claim 1, wherein the at least one processor is further configured to execute the instructions to:
analyze reaction of the posted product based on the reaction information; and
propose a sales promotion method for the posted product based on an analysis result.

6. The sales promotion proposal device according to claim 5, wherein the at least one processor is further configured to execute the instructions to:
analyze an attribute of the posted product based on the reaction information; and
propose a shelf allocation of a product in the store based on an attribute of the posted product.

7. The sales promotion proposal device according to claim 5, wherein the at least one processor is further configured to execute the instructions to:
analyze an attribute of a customer who pays attention to the posted product based on the reaction information; and
propose a content of a POP targeting the attribute of the customer.

8. A sales promotion proposal method causing a computer to execute:
acquiring posted information on a media of a product sold in a store and reaction information on an Internet to the posted information;
suggesting a sales promotion method in a store of a posted product posted on the media based on the posted information and the reaction information; and
outputting the suggested sales promotion method.

9. A non-transitory recording medium having stored therein a program for causing a computer to execute:
acquiring posted information on a media of a product sold in a store and reaction information on an Internet to the posted information;
suggesting a sales promotion method in a store of a posted product posted on the media based on the posted information and the reaction information; and
outputting the suggested sales promotion method.
